(19) United States
(12) Patent Application Publication
(10) Pub. No.: US 2018/0115559 A1
(43) Pub. Date: Apr. 26, 2018

(54) AGGREGATION AND PROVISION OF VERIFICATION DATA

(71) Applicant: VERIFIER PTY LTD, Brisbane, Queenslamd (AU)

(72) Inventor: Lisa Schutz, RICHMOND, VICTORIA (AU)

(21) Appl. No.: 15/573,428

(22) PCT Filed: May 18, 2016
(86) PCT No.: PCT/AU2016/050375

§ 371 Date: Nov. 10, 2017

(30) Foreign Application Priority Data
May 18, 2015 (AU) 2015901786

(51) Int. Cl. H04L 29/06; G06Q 40/02; G06F 17/30

(52) U.S. Cl. CPC H04L 63/126; G06F 17/30371; G06Q 40/025

(57) ABSTRACT

A computer implemented system comprises one or more data stores storing in one or more entity-specific data locations entity access protocols for determining access to verification data about a plurality of entities. A plurality of data sources communicated with the data stores via the communication network. Each data source provides verification data about one or more of the entities and data source access protocols are associated with each data source. In response to a request for verification data about the respective entity, verification data is communicated to a computing device for review by the respective entity by an arbitration engine in communication with the one or more data stores. Upon approval by the respective entity via the computing device, the verification data about the respective entity is provided to a requestor computing device via the at least one communications network.

### FIELD OF THE INVENTION

The present invention relates to the aggregation and provision of verification data. In particular, but not exclusively, the present invention relates to systems, methods and apparatus for aggregating and providing data for entities, such as individuals or businesses, by facilitating and controlling access thereto for the purposes such as assessing credit worthiness and/or generating a credit report and/or calculating a credit rating and/or establishing proof of good standing.

### BACKGROUND TO THE INVENTION

When a person submits an application, such as an application for a loan, a mortgage, a job, insurance, or to rent a property, the person is often required to provide proof of good standing, proof of their identity and/or employment position and/or evidence of credit worthiness, such as a credit rating or score or a credit report from a credit bureau and/or evidence of income, expenses and the like. Similar requirements must be met by businesses and/or their representatives when making applications on behalf of the business.

Obtaining the necessary information and performing the necessary checks is often a manually intensive, time consuming and therefore costly process. When the systems are automated, the information that can be shared and processes that third parties can use to provide information about people or businesses to lenders is often constrained by legislative and regulatory provisions to be adhered to, such as the National Consumer Credit Protection (NCCP) legislation and regulations in Australia, the Privacy Act and comparable legislation and regulations in other countries. The problem is exacerbated for institutions, such as banks or other lending institutions, which receive thousands of applications daily.

Each institution has typically developed its own procedures and a wide range of different approaches are used, for example, just to estimate and verify the income of applicants. Based on an NCCP benchmarking study in 2013, the work involved in manual income verification is estimated to have increased by 150%. The increased amount of work has led to a decline in service to customers resulting in longer application processing times and increased customer dropout rates.

Attempts to address the above problems include systems and methods of data gathering and scoring, which have resulted in the proliferation of third party organisations, such as credit bureaux, that provide such services. Such third parties are used extensively by institutions, such as banks or other lending institutions. Because of the sensitive nature of the information housed by credit bureaux, they are typically provided with exemptions to privacy rules with which most other organisations have to comply. In return, the credit bureaux are governed by very specific requirements in terms of the information they can share and limitations on the use of the information they collect. Credit bureaux are thus constrained by the model in which they exist as third parties.

Despite the constraints imposed on credit bureaux, consumers are concerned with the accuracy, integrity, security and availability of the personal information held by credit bureaux and contained in consumer credit reports.

Other problems associated with providing proof of standing and/or credit worthiness are faced by the young and those new to a particular country who have little or no credit history and have not yet had an opportunity to accumulate evidence by, for example, paying bills, taxes or the like.

### OBJECT OF THE INVENTION

It is a preferred object of the present invention to provide a system and/or a method and/or an apparatus for aggregating and providing verification data to, for example, facilitate establishing proof of standing and/or the preparation of credit reports and credit ratings/scores that address or at least ameliorate one or more of the aforementioned problems of the prior art and/or provides a useful commercial alternative.

### SUMMARY OF THE INVENTION

Generally, the present invention relates to computer-implemented systems, methods and apparatus for the aggregation and provision of verification data for entities, such as data relating to establishing proof of good standing, proof of identity and/or employment position, evidence of credit worthiness, such as a credit report, a credit rating or score or other verification purpose. The present invention can be used by entities, such as individuals and businesses and is entity-centric in that the present invention enables entities to aggregate and control the sharing of their own data with other parties.

In one form, although not necessarily the broadest form, the invention resides in a computer implemented system comprising:

one or more data stores for storing entity access protocols for determining access to verification data about a plurality of entities, the one or more data stores storing the entity access protocols for each entity in one or more entity-specific data locations; and

a plurality of data sources at least intermittently in communication with the one or more data stores via at least one communication network, each data source capable of providing verification data about one or more of the plurality of entities, data source access protocols being associated with each data source;

wherein, in response to a request for verification data about the respective entity from a requestor computing device having associated requestor access protocols, verification data is communicated to a computing device for review by the respective entity based on arbitration of the entity access protocols, the data source access protocols and the requestor access protocols by an arbitration engine in communication with the one or more data stores; and

upon approval by the respective entity via the computing device, the verification data about the respective entity is provided to the requestor computing device via the at least one communications network.

In another form, although not necessarily the broadest form, the invention resides in a computer implemented method comprising:

storing in one or more data stores entity access protocols for determining access to verification data about a plurality of entities, the one or more data stores storing the entity access protocols for each entity in one or more entity-specific data locations;

receiving, at one or more data stores, a request for verification data about a respective entity from a requestor computing device, the requestor computing device having associated requestor access protocols and being in communication with the one or more data stores via at least one communication network;

receiving at a computing device, verification data about the entity for review by the respective entity from one or more of a plurality of data sources at least intermittently in communication with the one more data stores via at least one communication network, provision of the verification data being based on arbitration of the entity access protocols, data source access protocols associated with each of the data sources and the requestor access protocols by an arbitration engine in communication with the one or more data stores;

receiving, at the data store, approval relating to the verification data from the respective entity via the computing device; and

providing the verification data about the respective entity to the requestor computing device via the at least one communications network.

In a further form, although not necessarily the broadest form, the invention resides in an apparatus comprising:

a processor in communication with a memory and an interface for communicating, via at least one communications network, with a plurality of data sources, each data source capable of providing verification data about the respective entity, data source access protocols being associated with each data source;

the memory comprising one or more entity-specific data locations, each entity-specific data location storing entity access protocols for determining access to the verification data about the respective entity;

wherein, in response to a request for verification data about the respective entity from a requestor computing device having associated requestor access protocols, verification data is communicated to a computing device for review by the respective entity based on arbitration of the entity access protocols, data source access protocols associated with each of the data sources and the requestor access protocols by an arbitration engine in communication with the one or more data stores; and

upon approval by the respective entity via the computing device, the verification data about the respective entity is provided to the requestor computing device via the at least one communications network.

Suitably, the verification data is data that can be used to establish one or more of the following: proof of good standing; proof of income; proof of identity; proof of employment position; evidence of credit worthiness, such as a credit report; a credit rating; a credit score.

Suitably, the data sources are selected from the following: a financial institution, such as a bank or credit union; an general insurance company; a medical insurance company; an employer; a payroll company; a rental agency; a credit agency or credit bureau; a superannuation fund or pension fund organisation; a government agency or department; an online trading company; an online third party payment company; an online reservation organisation, such as for accommodation, vehicles or travel tickets; a social media portal; a business relationship portal; a utility company; or other data sources capable of providing data for verification purposes.

Suitably, the one or more entity-specific data locations are implemented in the form of Persistent Internet Computing Objects (PICOs).

Suitably, communication between the one or more data stores and one or more of the data sources is via an application programming interface (API) or an entity-specific access application.

Suitably, the one or more entity-specific data locations store at least some of the verification data about the entity.

In some embodiments, at least some of the verification data is provided by the entity, for example, by uploading an electronic document to the entity-specific data location.

Suitably, the verification data is obtained by optical character recognition (OCR), screen scraping, web scraping, web data extraction, parsing or another data acquisition technique.

Preferably, the respective entity sets the entity access protocols to at least a sub-set of the data stored in the one or more entity-specific data locations for one or more third parties according to the purpose for which the third parties require the data. Suitably, this is achieved using an application which facilitates the sharing of entity-specific data with third parties.

Suitably, the entity access protocols and/or the data source access protocols and/or the requestor access protocols are for recurring access or one off access or access within a predetermined timeframe.

In some embodiments, entities opt in such that their data is used anonymously to generate one or more credit worthiness algorithms.

In some embodiments, entities opt in such that their data is used anonymously to generate one or more algorithms for another purpose based on the accessible entity-specific data for the other purpose for which the entities give permission.

The one or more credit worthiness algorithms may be used to calculate credit worthiness scores for the entities who have opted in. Similarly, the other purpose algorithms may be used for the other purpose for the entities that have opted in.

The credit worthiness or other purpose scores calculated using the algorithms can be shared with a third party if permitted by the access protocols set by the respective entity.

The verification data relating to proof of standing and/or credit rating assessment or the like may include the outcome and date of one or more earlier applications.

The system, method, or apparatus may further comprise a dynamic interface for presentation on the computing device to the respective entity, wherein a configuration of the dynamic interface is determined by one or more of the following: one or more of the data sources; the verification data about the respective entity requested by the requestor; the entity access protocols; data source access protocols; requestor access protocols.

Suitably, the respective entity may withhold approval via the computing device in relation to some or all of the requested verification data.

Suitably, the respective entity may submit one or more amendments via the computing device in relation to some or all of the requested verification data.

The entities may have a right of access to their respective verification data, for example under applicable privacy legislation.

Suitably, the entities request access to their respective verification data from the data source holding the verification data.

In a yet further form, although not necessarily the broadest form, the invention resides in a non-transitory computer readable medium having stored thereon program code instructions, the execution of at least some of the program code instructions effecting performance of the present invention.

Further forms and/or features of the present invention will become apparent from the following detailed description.

### BRIEF DESCRIPTION OF THE DRAWINGS

In order that the invention may be readily understood and put into practical effect, reference will now be made to preferred embodiments of the present invention with reference to the accompanying drawings, wherein like reference numbers refer to identical elements. The drawings are provided by way of example only, wherein:

FIG. 1 illustrates a system illustrating embodiments of the invention;

FIG. 2 illustrates an apparatus according to an embodiment of the invention;

FIG. 3A illustrates entity-specific data locations employed in some embodiments of the invention;

FIG. 3B illustrates entity-specific data locations, access protocols and connectivity employed in some embodiments of the invention; and

FIG. 4 is a general flow diagram of methods according to embodiments of the invention.

Skilled addressees will appreciate that elements in the drawings are illustrated for simplicity and clarity, may be schematic and have not necessarily been drawn to scale. For example, the relative dimensions of some of the elements in the drawings may be distorted to help improve understanding of embodiments of the present invention.

### DETAILED DESCRIPTION OF THE INVENTION

Generally, the present invention relates to computer-implemented systems, methods and apparatus for the aggregation and provision of verification data relating to, for example, establishing proof of good standing, proof of identity, proof of employment position, evidence of credit worthiness, such as a credit report, a credit rating or score, to provide personal-related evidence for another purpose or perform another type of validation or verification. The present invention enables entities, such as individuals and businesses, to aggregate and control the sharing of their own data with other parties, rather than relying on credit bureaux or other third parties to collate and share such data.

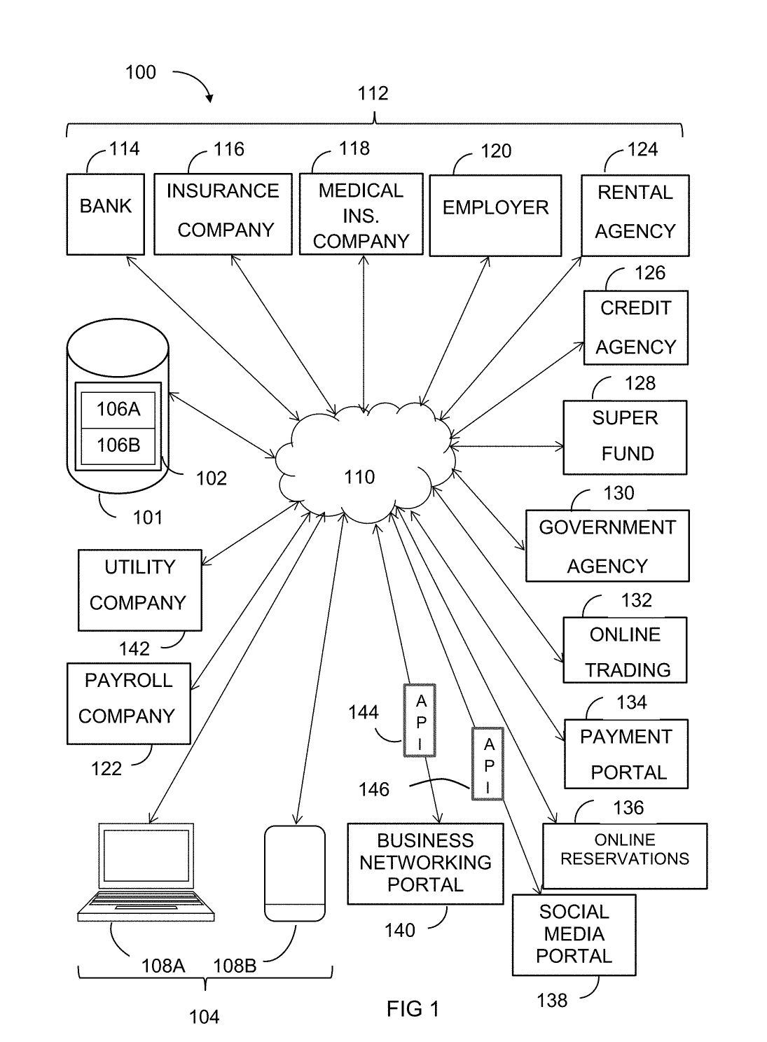

FIG. 1 is a schematic diagram of a computer implemented system 100 illustrating embodiments of the present invention. The system comprises an apparatus in the form of a server 101 comprising a data store 102 for storing data, and in particular entity access protocols, permissions or rules for accessing and/or acquiring verification data about an entity relating to, for example, establishing proof of standing and/or a credit rating assessment or the like for a plurality of entities 104. It should be appreciated that whilst one data store 102 is shown in FIG. 1, embodiments of the present invention can comprise more than one data store 102 in the same location or in distributed locations. Each entity can be an individual, a company, business or other organisation that may wish to prove their good standing, prove their identity and/or employment position, provide evidence of credit worthiness, such as establish a credit report or credit rating, or provide personal-related evidence for another purpose or perform another type of validation or verification. The data store 102 stores entity access protocols, rules or permissions to access verification data for each entity in one or more entity-specific data locations 106A, 106B. The possible forms of the entity-specific data locations 106 envisaged are discussed further herein. In some embodiments, data store 102 can also store at least some of the verification data about the entity on behalf of the entity.

The system 100 can be considered to include a computing device 108A, 108B for each respective entity 104, which is in communication with the data store 102 via at least one communication network 110. Computing devices 108A, 108B can be any computing device known in the art having the necessary processing and communication capabilities, such as a laptop, notebook or desktop computer, a smart phone, a tablet, a phablet, a PDA or a multi-media device.

Whilst FIG. 1 shows two computing devices 108A, 108B for two different entities 104, each having their respective entity-specific data location 106A, 106B in the data store 102, it will be appreciated that the present invention can serve a large number of entities.

The system 100 can be considered to include a plurality of data sources 112 at least intermittently in communication with the one or more data stores 102 via the at least one communication network 110. Each data source 112 is capable of providing verification data relating to, for example, establishing proof of good standing, proof of identity and/or employment position, evidence of credit worthiness, such as a credit report, a credit rating or score, of the plurality of entities 104. Data source access protocols are associated with each data source which influence the availability and accessibility of the verification data about an entity as described herein. Data source access protocols can be stored with the respective data sources 112 or elsewhere, such as in data stores 102.

As shown in FIG. 1, the data sources 112 can be selected from the following: a financial institution 114, such as a bank or credit union; an general insurance company 116; a medical insurance company 118; an employer 120; a payroll company 122; a rental agency 124; a credit agency or credit bureau 126; a superannuation fund or pension fund organisation 128; a government agency or department 130, such as a tax office or inland revenue; an online trading company 132; an online third party payment company 134; an online reservation organisation 136, such as for accommodation, vehicles or travel tickets; a social media portal 138; a business relationship portal 140; a utility company 142 or other data sources currently or in the future capable of providing data for verification purposes. The provision of data by the data sources 112 to the one or more data stores 102 is described in more detail herein. It should be appreciated that one or more of the data sources 112 can also be a requestor of verification data for an entity.

In the system 100, the verification data provided by one or more of the plurality of data sources 112 and in some embodiments stored in their one or more entity-specific data locations 106, and the accessibility of such data, is controlled at least in part by the entity access protocols for each respective entity, and in some embodiments, via their respective computing device 108. It will be appreciated that the computing device used by the entity to control the content and accessibility of their data may change over time and the present invention is not limited to the entity 104 always using the same computing device 108. In some embodiments described herein, reference is made to a requestor computing device which may be viewed by the entity.

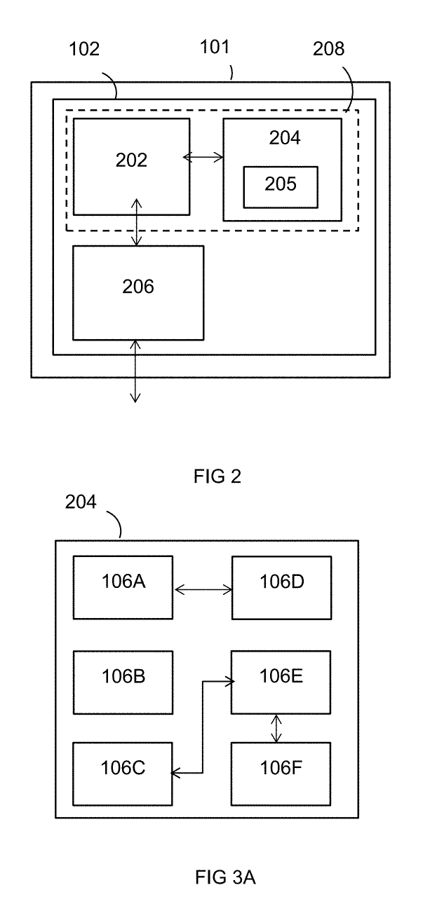

FIG. 2 is a schematic of an apparatus 101 according to one embodiment of another form of the invention. The apparatus 101, in the form of the server comprising data store 102 shown in FIG. 1, comprises at least a processor 202 in communication with a memory 204 and an interface 206 for communicating via the at least one communications network 110. The processor 202 and the interface 206 can be any known processor and communication interface respectively of suitable performance and capability which enables the apparatus 101 to communicate with, for example, computing devices 108 for the respective entities 104 and the plurality of data sources 112.

The memory 204 comprises a non-transitory computer readable medium 205 having stored thereon program code instructions, the execution of at least some of the program code instructions effecting performance of the present invention. In some embodiments, processor 202 and memory 204 constitute an arbitration engine 208 of, or in communication with, data store 102 for performing arbitration of the entity access protocols, data source access protocols associated with each of the data sources and the requestor access protocols associated with each requestor to determine availability and accessibility of the verification data.

According to some embodiments, the memory 204 comprises a plurality of the entity-specific data locations 106. In response to a request from the computing device 108 of a respective entity, or in some embodiments a third party, the apparatus 101 stores the entity access protocols or permissions to access verification data about the entity relating to, for example, establishing proof of good standing, proof of identity and/or employment position, evidence of credit worthiness, such as a credit report and/or a credit rating or score or the like in the one or more entity-specific data locations 106 of the respective entity. The verification data received from one or more of the plurality of data sources 112, and the accessibility of such data, is controlled by the respective entity 104, via their respective computing device 108, or another computing device, as discussed in more detail herein.

It will be appreciated that apparatus 101 may well comprise other features not shown in FIG. 2 or described herein required for the operation of the apparatus that will nonetheless be familiar to the skilled addressee.

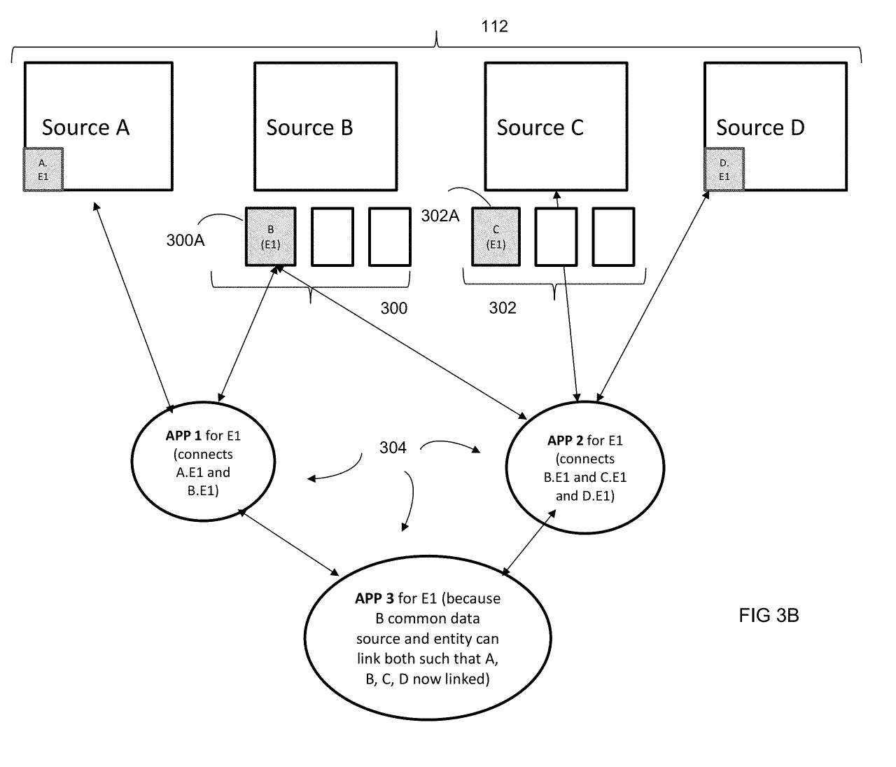

With reference to FIG. 3A, the example shows six entity-specific data locations 106A, 106B, 106C, 106D, 106E and 106F in memory 204, which can store at least some of the verification data for the respective entity and/or entity access protocols or permissions to access such data, which can be stored elsewhere, such as in or with data sources 112.

In some embodiments, each entity-specific data location is for a different entity and there is no link, connection or communication between the entity-specific data locations.

In other embodiments, each entity is assigned more than one entity-specific data location 106 and connectivity can exist between multiple locations 106 of a single entity.

In further embodiments, connectivity or communication exists between the entity-specific data locations of different entities. In the example shown in FIG. 3A, connectivity or communication exists between the entity-specific data locations 106A and 106D, between locations 106C and 106E and between locations 106E and 106F. In such embodiments, the connectivity is set/requested/accepted by the entity in control of the respective entity-specific data location. Therefore, in some embodiments the connectivity between locations 106A and 106D, for example, requires one of the entities in control of the entity-specific data location 106A to request connectivity and the other entity in control of the entity-specific data location 106B has the option to accept or decline the request for connectivity, or vice versa. Similarly, the specific data that can be shared or exchanged is controlled by the entities according to the access protocols.

In yet further embodiments, connectivity between entity-specific data locations 106A and 106D is dependent on one of the data sources 112 or other third party that controls the platforms/infrastructure on which entity-specific data locations 106A and 106D reside. Sharing of data between entity-specific data locations 106A and 106D depends on the level to which the relevant data sources 112 or other third parties agree as determined by the data source access protocols and the requestor access protocols.

In other embodiments the one or more entity-specific data locations 106 for each entity is in the form of, or is implemented by, a Persistent Internet Computing Object (PICO). The contents and accessibility of the PICO is controlled by the entity to which the PICO relates. The PICO can run one or more applications autonomously and can respond to specific events, such as requests for information. The PICO can comprise structured and unstructured data, can be written in any programming language and can connect to one or more other PICOs. This functionality depends on the permissions set by the entity via the entity access protocols, but provides flexibility and efficiency in the provision and operation of embodiments of the present invention.

Reference is now made to FIG. 3B, which shows four different data sources 112—Source A, Source B, Source C and Source D, each of which is capable of providing verification data about an entity. According to some embodiments of the present invention, some of the data sources 112 have associated data source access protocols in the form of applications that can be a separate data store or a persistent permission to access verification data stored by the data source 112. In the example shown in FIG. 3B, Source B has associated applications 300 and Source C has associated applications 302. Sources A and D do not have any associated applications, but store verification data. For example, Source A stores a record (A.E1) for entity E1 and Source D stores a record (D.E1) for entity E1.

One of the applications associated with Source B, entity-specific application 300A, can be data (B.E1) for entity E1 or a persistent permission to access data in Source B for entity E1. Similarly, one of the applications associated with Source C, entity-specific application 302A, can be data (C.E1) for entity E1 or a persistent permission to access data in Source C for entity E1.

The example shown in FIG. 3B also shows further applications 304, such as entity access protocols in the form of APP1, APP2 and APP3, which further illustrate the data sharing ecosystem of the present invention that facilitates the data aggregation for an entity E1. APP1 connects to data A.E1 in Source A and to the application storing or providing access to data or permissions to access data B.E1 in Source B. APP2 connects to the application 302A storing or providing access to B.E1 in Source B, to the application storing or providing access to data or permissions to access data C.E1 in Source C and directly to data D.E1 in Source D. APP3 for entity E1 connects to APP1 and to APP2 and can therefore link to all four data sources, Sources A to D to obtain verification data for entity E1. APP3 has incidental access to the access application APP1 has to Source B for data relating to entity E1 only to the extent that i) APP1 provides access to APP3; ii) the data from Source B that APP1 possesses or has access to for entity E1 is sufficient for APP3; iii) the access protocols/arrangements/permissions Source B has with APP1 allow APP1 to share the data with APP3; and iv) APP1 is the arbiter of the rules of access. For example, its own policies or policies with Source A or Source B may determine that data need not be shared with APP3.

It should be appreciated that whilst the data sharing ecosystem shown in FIG. 3B could be implemented by means of PICOs, it need not be. The data sharing ecosystem shown in FIG. 3B could be implemented using applications comprising APIs, storage, logic and/or user interfaces, as required.

In some embodiments, communication between the one or more data stores 102 of apparatus 101 and one or more of the data sources 112 is via an application programming interface (API). With reference to FIG. 1, an API 144 is in place to access information from the business networking portal 140, an example of which is LinkedIn. Information about an entity on their profile on such a business networking portal 140 can be used, for example, to establish the professional reputation of the entity, which in turn may be used as an indicator of income reliability. FIG. 1 also shows an API 146 in place to access information relating to the entity on the social media portal 138, examples of which include Facebook and Twitter. Information about an entity based on their social media activity can be used, for example, to establish whether the entity has a low, medium or high risk lifestyle, for example, for insurance purposes.

In some embodiments, some of the verification data relating to establishing proof of standing and/or generating a credit report and/or assessing a credit rating or the like of the entity is provided by the entity 104. For example, the entity-specific data location 106 in the data store 102 can receive and store an electronic document uploaded by the entity. The electronic document can be in any suitable format, such as, but not limited to pdf, jpg, jpeg or bmp and could, for example, show a pay slip, bank statement, utility bill, rental payment receipts, mortgage payments and/or balance or other information that could relate to establishing proof of good standing, proof of identity and/or employment position, evidence of credit worthiness, such as a credit report, a credit rating/score or the like.

In some embodiments, the data relating to establishing proof of standing, assessing a credit rating or the like of the entity is obtained by optical character recognition (OCR), screen scraping, web scraping, web data extraction, parsing or another data acquisition technique. One or more of these techniques can corroborate evidence obtained from another source and/or enable the relevant data to be expanded.

In preferred embodiments, the respective entity 104 sets the entity access protocols, accessibility settings or permissions to a sub-set of the data stored in the entity-specific data location 106. The accessibility settings or permissions can be set for each of one or more third parties according to the purpose for which the third parties require the data. In some situations, the entity access protocols, accessibility settings or permissions are for recurring access by the third parties whereas in other situations only one off access is permitted by the third parties. For example, an entity 104 can provide a financial institution, such as a bank 114, one off access to a sub-set of the data stored in the one or more entity-specific data locations 106 that the bank 114 requires to assess a mortgage application. Other data stored for the same entity in the one or more entity-specific data locations 106 that are not required for the mortgage application would not be accessible by the bank 114.

In some embodiments, entities 104 opt in, for example via a check box or menu selection in a user interface for, or otherwise associated with their entity-specific data location 106, such that their data, or a sub-set thereof, is used anonymously to generate one or more credit worthiness algorithms. The one or more credit worthiness algorithms can be used to calculate credit worthiness scores for the entities who have opted in. The credit worthiness scores can be shared by each entity with a third party if permitted by the entity access protocols, accessibility settings or permissions set by the respective entity.

Hence, embodiments of the invention include generating credit worthiness scores for entities based on the entity's data as part of a collective of multiple entities. The entities then have the choice to share their credit score and with whom. This is in contrast to the generation of credit scores by credit bureaux for a third party, such as a bank, as part of, for example, a loan application process, where the choice of whether to use the score, and participate in the data pool that creates the algorithm for the score, belongs to the third party not the entity.

In some embodiments, entities 104 opt in, for example via a check box or menu selection in a user interface for, or otherwise associated with their entity-specific data location 106, such that their data, or a sub-set thereof, is used anonymously to generate one or more algorithms for another purpose for which the entity gives permission.

In some embodiments, the data relating to establishing proof of good standing, proof of identity and/or employment position, evidence of credit worthiness, such as generating a credit report or a credit rating or score or other verification purpose, can include the outcome and date of one or more earlier applications where entities 104 have, for example, via a check box or menu selection, agreed to be remembered by the one or more data stores 102. Connectivity can be established with the relevant institution(s) with which the earlier applications were filed and permissions can be set such that the data relating to such applications can be collected directly and stored in the one or more entity-specific data locations 106 for the respective entity. Successful outcomes of earlier applications, such as loan or mortgage applications, and the date of such outcomes, can streamline subsequent application processes.

Preferred embodiments of the present invention comprise a dynamic interface for presentation on the computing device 108A, 108B of the respective entity. A configuration of the dynamic interface is determined by one or more of the following: one or more of the data sources 112; the verification data about the respective entity requested by the requestor; the entity access protocols; the data source access protocols; the requestor access protocols.

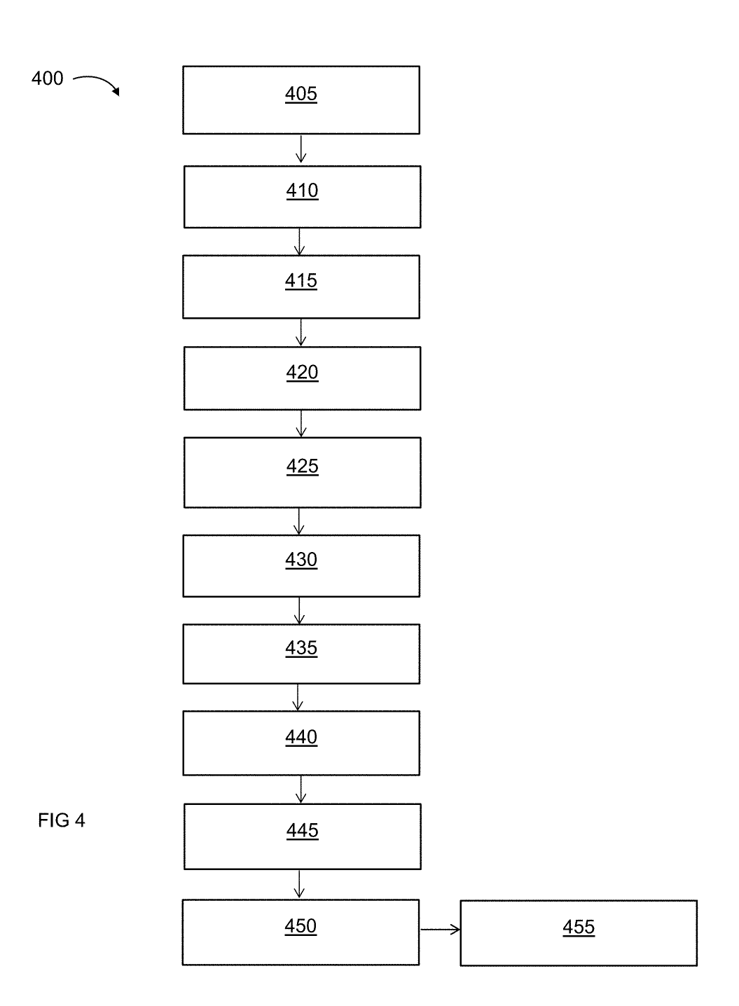

With reference to the flow diagram in FIG. 4, embodiments of a further form of the present invention reside in computer implemented methods 400. The computer implemented methods are directed to methods of verification or data access, acquisition or aggregation for entities, such as for verifying proof of good standing, proof of identity and/or employment position, evidence of credit worthiness, such as establishing a credit rating or score, generating a credit report or other verification purpose.

The methods 400 comprise at 405, for example, the entity 104 making an application, for example, for a loan, a mortgage, a rental property or for some other purpose that requires verification or validation of data. Alternatively, step 405 can represent a requestor, such as a health insurance company, requesting verification data about an entity.

At 410, the method includes the organisation to which the application is being made providing the entity 104 with the option to use an embodiment of the present invention in the application process. The option can be presented to the entity, for example, via a user interface, such as a website, displayed on the entity's computing device 108, via which the entity is making their application. Alternatively, a requestor of verification data about an entity can provide the entity 104 with the option to use an embodiment of the present invention. Alternatively, using an embodiment of the present invention can be a compulsory part of an application or data acquisition process.

If an embodiment of the present invention is used in the application process, methods 400 comprise at 415 the entity being directed to or taken to a separate web portal which guides the entity through the subsequent process.

The methods 400 comprise at 420 receiving, at the apparatus 101 comprising one or more data stores 102, a request from the computing device 108 of a respective entity to store entity access protocols or permissions for verification data about the entity relating to, for example, proof of standing, a credit rating assessment or the like. The computing device 108 is in communication with the apparatus 101 and one or more data stores 102 via at least one communication network 110 as described herein.

At 425, the method comprises apparatus 101 receiving verification data relating to the entity from one or more of the plurality of data sources 112 having proven authorisation to access the verification data via a tailored set of criteria as prescribed by the data source 112. Each of the one or more data sources 112 providing the data is at least intermittently in communication with the apparatus 101 and one or more data stores 102 via the at least one communication network 110 or via another communication network. The communication network(s) employed in the communication of data between the data sources 112 and the one or more data stores 102 can depend on the nature of the data source providing the information and/or the nature of the data being communicated. One or more levels of encryption can be employed in the transmission of the data. It should be appreciated that in some scenarios, access to one or more of the data sources 112 might have occurred before the application process commences. If access to one of the data sources 112 is already established and one or more of the entity-specific data locations 106 is a physical memory, this will result in the most efficient model. If the one or more entity-specific data locations 106 is virtual, this will still be an efficient model subject to the communications network 110. If authority to access the data of one or more of the data sources 112 has to be re-established, the efficiency of the model may be reduced.

At 430, the method 400 comprises storing entity access protocols or permissions for verification data for the entity in the entity-specific data location 106 of the one or more data store 102. The verification data provided by one or more of the plurality of data sources 112 can be optionally stored in their entity-specific data location 106, and the accessibility of such data is determined by the access protocols, which is controlled by each entity 104, for example, via their respective computing device 108. In some cases, entities have a respective right of access to their verification data. In response to a request for verification data about the respective entity, verification data is communicated to the computing device 108A, 108B of the respective entity based on the entity access protocols stored for the respective entity, the data source access protocols and the requestor access protocols. Arbitration engine 208 performs arbitration of the entity access protocols, the data source access protocols and the requestor access protocols to resolve any competing priorities.

Upon approval by the respective entity via their respective computing device 108A, 108B, or via another computing device, such as a requestor's computing device, the verification data about the respective entity is provided to the requestor's computing device via the at least one communications network 110. In some embodiments, the entity can withhold approval via their respective computing device 108a, 108B, or another computing device, in relation to some or all of the requested verification data. In some embodiments, the respective entity can submit one or more amendments or corrections via their respective computing device 108A, 108B or another computing device, in relation to some or all of the requested verification data. In some embodiments an amendment/correction message is communicated to the relevant data source.

The method 400 can comprises at 435 the one or more data stores 102 receiving entity access protocols, accessibility settings or permissions from the computing device 108 of the entity 104. The accessibility settings or permissions can be for access to a sub-set of the data stored in the one or more entity-specific data locations 106 for the respective entity. The accessibility settings or permissions determine the data to which one or more third parties have access. The accessibility settings or permissions can be for recurring access or one off access and can vary between third parties according to the purpose for which the third parties require the data. In some embodiments, at the time the application form is presented to the user, the option might be given to use prior accessibility settings or permissions or default to global entity-specific settings, such as always share, once off, with a predetermined or specified time frame, not repeatedly or the reverse. This option can be in relation to all data or a sub-set of the data stored for the respective entity. In some instances, entity access protocols, data source access protocols and/or requestor access protocols can relate to price or cost. For example, one or more of the entity access protocols, data source access protocols and/or requestor access protocols can specify that the entity, data source and/or requestor will or will not pay for certain verification data from certain sources. The entity access protocols, data source access protocols and/or requestor access protocols can also specify billing data.

At 440, the method 400 comprises the one or more data store 102 receiving an opt in selection or request from the computing device 108 of the entity 104 such that the data for that entity, or a subset thereof, can be used anonymously to generate one or more credit worthiness algorithms, or algorithms for another purpose. At 445, the method includes generating the one or more credit worthiness algorithms, or algorithms for another purpose.

The method 400 can comprise at 450 the one or more data stores 102 calculating credit worthiness scores or ratings or calculations for another purpose, for the entities who have opted in using the one or more credit worthiness algorithms. In some embodiments, this could be performed using machine learning or via a data analyst. The process involves aggregating the anonymous data across the entities that have opted in.

At 455, the method 400 can comprise the one or more data stores 102 receiving accessibility settings or permissions from the computing device 108 of the entity 104 to share their credit worthiness score with a third party. In some embodiments, the entity sets global permissions or settings initially, for example as part of a set up process, and is prompted to check or modify them for specific actions rather than setting them from scratch for each action.

The present invention thus addresses or at least ameliorates one or more of the aforementioned problems of the prior art in that the computer-implemented systems, methods and apparatus of the present invention provide an entity-centric means of aggregating, providing and controlling access to verification data through entity access protocols, data source access protocols and requestor access protocols and permissions and the arbitration engine. The verification data can relate to establishing, for example, proof of good standing, proof of identity and/or employment position, evidence of credit worthiness, such as establishing a credit report, a credit rating or score. Embodiments of the present invention are outside the known credit bureaux model and are not subject to the restrictions associated therewith. By virtue of the present invention, entities are able to compile their own data and evidence upon which verification processes, such as proof of standing and credit worthiness assessments, are based. Entities can therefore ensure the accuracy and currency of their own verification data. Entities have a right of access to their verification data and the present invention enables the entity to review the data before it is provided to the requestor or third party. In contrast, in the third party model, entities are not necessarily made aware of the data shared about them and there can be persistent errors in such data. Additionally, as previously discussed, the data shared is limited in the third party model and the present invention seeks to resolve that by providing entities with the ability to provide their proof of standing. Not all data sources are willing to invest in providing access to respective entities of the data to which those entities have a right of access. By enabling pricing to be set by data sources, this embodiment also resolves the issue of increasing the amount of data stores that entities can access in order to compile their verification data.

Where the opt in option is selected according to some embodiments, the entity is also aware that a credit assessment or the like is being performed, unlike in current scenarios. Access protocols and permissions to access the verification data are conveniently stored in the one or more entity-specific data locations 106 and the accessibility of the data is controlled by the entity, rather than by a third party. Access to the data can be set by the entity on a once-only basis or on a recurring basis and different subsets of data can be selected for access by third parties according to the purpose and the recipient of the data.

According to at least some embodiments, the aggregation of data for the entity is further facilitated by the data sharing ecosystem utilising one or more entity-specific applications associated with data sources. The interconnectivity of multiple entity-specific applications further facilities data aggregation and provision by and for the entity, whilst maintaining the security of the data by virtue of the application-specific permissions set by the entity and/or the data source 112. This allows the boundaries between organisations that exist with known systems and methods to be reduced if not eliminated.

Therefore, embodiments of the present invention provide a more efficient and cost effective means for entities and institutions to access and share accurate verification data as is typically required to establish proof of good standing, proof of identity and/or employment position, evidence of credit worthiness, such as generating a credit report, calculating a credit rating or score or performing another type of verification or validation process. The flexibility of the present invention, such as the functionality allowing the entity to be “remembered”, avoids the need for the same data to be re-submitted and re-analysed when the data is already available in the one or more entity-specific data locations 106.

Since entities are aggregating and/or providing the verification data relating to themselves, for example from the data sources 112, rather than a third party, such as a credit bureaux, performing the aggregation, the entities are not subject to the same privacy regimes as credit bureaux that operate in many countries. Therefore, a global credit report or universal credit worthiness “passport” is possible, which facilitates cross border lending and the operation of peer to peer lenders globally.

Embodiments of the present invention enable those who typically encounter difficulties in establishing, for example a credit rating, such as the young or those new to a country, to do so and participate in society when otherwise they may be excluded.

Embodiments of the present invention can also simplify a wide range of processes such as, and which are impacted by, changing address, changing insurer, changing employment.

In this specification, the terms “comprises”, “comprising” or similar terms are intended to mean a non-exclusive inclusion, such that an apparatus that comprises a list of elements does not include those elements solely, but may well include other elements not listed.

The reference to any prior art in this specification is not, and should not be taken as, an acknowledgement or any form of suggestion that the prior art forms part of the common general knowledge.

Throughout the specification the aim has been to describe the invention without limiting the invention to any one embodiment or specific collection of features. Persons skilled in the relevant art may realize variations from the specific embodiments that will nonetheless fall within the scope of the invention.

1. A computer implemented system comprising:
one or more data stores for storing entity access protocols for determining access to verification data about a plurality of entities, the one or more data stores storing the entity access protocols for each entity in one or more entity-specific data locations; and
a plurality of data sources at least intermittently in communication with the one or more data stores via at least one communication network, each data source capable of providing verification data about one or more of the plurality of entities, data source access protocols being associated with each data source;
wherein, in response to a request for verification data about the respective entity from a requestor computing device having associated requestor access protocols, verification data is communicated to a computing device for review by the respective entity based on arbitration of the entity access protocols, the data source access protocols and the requestor access protocols by an arbitration engine in communication with the one or more data stores; and
upon approval by the respective entity via the computing device, the verification data about the respective entity is provided to the requestor computing device via the at least one communications network.

2. A computer implemented method comprising:
storing in one or more data stores entity access protocols for determining access to verification data about a plurality of entities, the one or more data stores storing the entity access protocols for each entity in one or more entity-specific data locations;
receiving, at one or more data stores, a request for verification data about a respective entity from a requestor computing device, the requestor computing device having associated requestor access protocols and being in communication with the one or more data stores via at least one communication network;
receiving, at a computing device, the verification data about the entity for review by the respective entity from one or more of a plurality of data sources at least intermittently in communication with the one or more data stores via at least one communication network, provision of the verification data being based on arbitration of the entity access protocols, data source access protocols associated with each of the data sources and the requestor access protocols by an arbitration engine in communication with the one or more data stores;
receiving, at the data store, approval relating to the verification data from the respective entity via the computing device; and
providing the verification data about the respective entity to the requestor computing device via the at least one communications network.

3. An apparatus comprising:
a processor in communication with a memory and an interface for communicating, via at least one communications network, with a plurality of data sources, each data source capable of providing verification data about the respective entity, data source access protocols being associated with each data source;
the memory comprising one or more entity-specific data locations, each entity-specific data location storing entity access protocols for determining access to the verification data about the respective entity;
wherein, in response to a request for verification data about the respective entity from a requestor computing device having associated requestor access protocols, verification data is communicated to a computing device for review by the respective entity based on arbitration of the entity access protocols, the data source access protocols and the requestor access protocols by an arbitration engine in communication with the one or more data stores; and
upon approval by the respective entity via the computing device, the verification data about the respective entity is provided to the requestor computing device via the at least one communications network.

4. The apparatus of claim 3, wherein the verification data about the entity relates to establishing one or more of the following: proof of good standing, proof of income, proof of identity and/or employment position, evidence of credit worthiness, such as a credit report, a credit rating, or a credit score.

5. The apparatus of claim 3, wherein the data sources are selected from the following: a financial institution, such as a bank or credit union; an general insurance company; a medical insurance company; an employer; a payroll company; a rental agency; a credit agency or credit bureau; a superannuation fund or pension fund organisation; a government agency or department; an online trading company; an online third party payment company; an online reservation organisation, such as for accommodation, vehicles or travel tickets; a social media portal; a business relationship portal; a utility company or other data sources capable of providing data for verification purposes.

6. The apparatus of claim 3, wherein the one or more entity-specific data locations are implemented in the form of Persistent Internet Computing Objects (PICOs).

7. The apparatus of claim 3, wherein communication between the one or more data stores and one or more of the data sources is via an application programming interface (API).

8. The apparatus of claim 3, wherein the one or more entity-specific data locations store at least some of the verification data about the entity.

9. The apparatus of claim 3, wherein at least some of the verification data about the entity is provided by one or more of the following:
a) the entity uploading an electronic document to the one or more entity-specific data locations;
b) optical character recognition (OCR), screen scraping, web scraping, web data extraction, parsing or another data acquisition technique.

10. The apparatus of claim 3, wherein the respective entity sets the entity access protocols to at least a sub-set of the data stored in the one or more entity-specific data locations for one or more third parties according to the purpose for which the third parties require the data.

11. The apparatus of claim 3, wherein the entity access protocols and/or the data source access protocols and/or the requestor access protocols are for one of the following: recurring access; one off access; access within a predetermined timeframe.

12. The apparatus of claim 3, wherein entities opt in such that their verification data is used anonymously to generate one or more credit worthiness algorithms, or other purpose algorithms, based on the accessible entity-specific data for another purpose for which the entities give permission.

13. The apparatus of claim 12, wherein the verification data is used to calculate credit worthiness scores, or other purpose calculations, for the entities who have opted in.

14. The apparatus of claim 13, wherein the credit worthiness scores are shared with a third party if permitted by the entity access protocols set by the respective entity.

15. The apparatus of claim 3, further comprising a dynamic interface for presentation on a computing device to the respective entity, wherein a configuration of the dynamic interface is determined by one or more of the following: one or more of the data sources; the verification data about the respective entity requested by the requestor; the entity access protocols; the data source access protocols; the requestor protocols.

16. The apparatus of claim 3, wherein the respective entity withholds approval via the computing device in relation to some or all of the requested verification data.

17. The apparatus of claim 3, wherein the respective entity submits one or more amendments via the computing device in relation to some or all of the requested verification data.

18. The apparatus of claim 3, wherein the entities have a right of access to their respective verification data.

19. The apparatus of claim 3, wherein the entities request access to their respective verification data from the data source holding the verification data.

20. The apparatus of claim 3, wherein one or more or the entity access protocols, data source access protocols and/or requestor access protocols relate to one or more of the following: a price associated with the provision of verification data; billing data.

21. A non-transitory computer readable medium having stored thereon program code instructions, the execution of at least some of the program code instructions performing the method of claim 2.
